(19) United States
(12) Patent Application Publication
(10) Pub. No.: US 2026/0162375 A1
(43) Pub. Date: Jun. 11, 2026

(54) METHOD AND ELECTRONIC DEVICE FOR REMOTELY CONTROLLING EXECUTOR’S ACTIONS IN REAL-TIME

(71) Applicant: SAY Organization OÜ, Narva (EE)

(72) Inventor: Pavel Malinovskiy, Olgina (EE)

(73) Assignee: SAY Organization OÜ, Narva (EE)

(21) Appl. No.: 18/970,309

(22) Filed: Dec. 5, 2024

(51) Int. Cl. G06T 19/00

(52) U.S. Cl. CPC G06T 19/003; G06T 19/006

(57) ABSTRACT

A method and an electronic device for remotely controlling an executor's actions in real-time. The method includes establishing a connection between a first electronic device and a second electronic device for rendering a stream on the first electronic device, the rendering is based on a feed of a real-world location captured by a camera of the second electronic device; rendering a user interface on the first electronic device, the user interface includes a set of user interface elements overlaid on the stream; generating commands based on inputs from the instructor received via the set of user interface elements; and controlling the second electronic device for execution of the commands for managing functionalities of the second electronic device or overlaying instruction elements on the feed, the instruction elements direct an executor to perform actions in the real-world location.

### TECHNICAL FIELD

The present disclosure relates to remote interaction controlling of actions of a person/device. The present disclosure also relates to a method and an electronic device for remotely controlling an executor's actions in real-time.

### BACKGROUND

Traditional remote communication platforms (such as video conferencing or tele conferencing), which enable users to broadcast and communicate remotely, are likely to be limited to one-way interaction. These platforms primarily focus on enabling participants to remotely observe (which may be usually passive) a speaker and facilitate limited interaction (such as word exchange) with the speaker. Additionally, these platforms may be constrained by latency issues, limited capability to control events during the conference, and a lack of immersive experience. These limitations become particularly problematic in scenarios where real-time decision-making and active participation are crucial, such as in remote education, virtual tourism, live event coverage, technical support, and so on. For example, existing video conferencing systems may facilitate visual and auditory communication but may be able to not provide features that enable a participant at one side to manipulate or guide physical actions with another participant at the other side in real-time. This can be a bottleneck in circumstances requiring hands-on interaction or immediate response.

Remote management and control systems, however, may enable users to control virtual avatars or virtual objects within a digital environment. However, they cannot extend such features as providing capability to the users to control actions in the real-world. Thus, any form of interactivity is confined to the virtual space. Furthermore, such systems lack essential features and capabilities such as real-time synchronization and feedback that is necessary for real-world applications. Although systems such as Peer-to-Peer (P2P) streaming allow for direct exchange of multimedia content between devices to take place, they do not inherently support control of physical actions or provide an interactive user interface for real-time management of such physical actions.

In summary, existing systems do not offer a comprehensive solution that combines multimedia streaming with real-time control of physical actions. Users are often limited to passive observation without the ability to direct actions of a remote participant or interact with the remote participant. The existing systems may not be able to effectively manage challenges associated with maintaining latency, particularly during synchronization of real-time actions across distances. This leads to delays that may disrupt interaction and reduce effectiveness of the communication. Many existing solutions may not be equipped with features to support real-time feedback from the remote participant or environment, making it difficult for users to assess and adjust their actions based on a current situation. Furthermore, the existing systems are designed for specific purposes and functions (such as video conferencing, virtual avatar control, and so on) and do not offer versatility required for real-time control of actions of a remote participant across a broad range of applications (such as remote education, technical support, virtual tourism, and so on).

Therefore, considering the foregoing discussion, there exists a need to overcome the aforementioned drawbacks.

### SUMMARY

The aim of the present disclosure is to provide method and an electronic device for remotely controlling an executor's actions in real-time (or near real-time). The method facilitates real-time interactive control of actions of a remote executor using the electronic device. The real-time interactive control involves multimedia streaming and real-time event and command transmission. The electronic device renders an interactive user interface to enable an instructor to remotely manage and control the actions of the executor. This enhances immediacy and responsiveness of remote interactions. The aim of the present disclosure is achieved by the provided method and the electronic device for remotely controlling the executor's actions in real-time as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers, or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates a first electronic device on which a first user interface is rendered for remotely directing an executor to perform one or more actions, in accordance with an embodiment of the present disclosure;

FIGS. 2A and 2B illustrate rendering of a second user interface on the first electronic device at different instances, in accordance with an embodiment of the present disclosure;

FIG. 3 illustrates an exemplary controlling of a second electronic device by the first electronic device for execution of a command to rotate the second electronic device, in accordance with an embodiment of the present disclosure;

FIG. 4 illustrates an exemplary controlling of the second electronic device by the first electronic device for execution of a command to rotate the second electronic device, in accordance with an embodiment of the present disclosure;

FIG. 5 illustrates an exemplary controlling of the second electronic device by the first electronic device for execution of a command to rotate the second electronic device, in accordance with an embodiment of the present disclosure;

FIG. 6 illustrates an exemplary controlling of the second electronic device by the first electronic device for execution of a command to rotate the second electronic device, in accordance with an embodiment of the present disclosure;

FIG. 7 illustrates an exemplary controlling of the second electronic device by the first electronic device for execution of a command to rotate the second electronic device, in accordance with an embodiment of the present disclosure;

FIG. 8 illustrates an exemplary controlling of the second electronic device by the first electronic device for execution of a command to rotate the second electronic device, in accordance with an embodiment of the present disclosure;

FIG. 9 illustrates an exemplary controlling of the second electronic device by the first electronic device for overlaying a reaction of the instructor on the second electronic device, in accordance with an embodiment of the present disclosure;

FIG. 10 illustrates an exemplary controlling of the second electronic device by the first electronic device for changing an orientation of the second electronic device, in accordance with an embodiment of the present disclosure;

FIG. 11 illustrates an exemplary controlling of the second electronic device by the first electronic device for execution of a command to direct an executor to physically move towards a certain direction, in accordance with an embodiment of the present disclosure; and

FIG. 12 illustrates steps of a method for remotely directing an executor to perform one or more actions, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides a method for remotely directing an executor to perform actions, the method comprising:
establishing, by a first electronic device associated with an instructor, a connection with a second electronic device associated with the executor, wherein the connection enables rendering a stream on the first electronic device, and wherein the rendering is based on a feed of a real-world location that is captured by a camera of the second electronic device and rendered on the second electronic device;
rendering a first user interface on the first electronic device, wherein the first user interface includes a first set of user interface elements overlaid on the stream rendered on the first electronic device, wherein the first set of user interface elements enables the instructor to control the second electronic device;
generating one or more commands based on reception of one or more inputs from the instructor via the one or more user interface elements of the first set of user interface elements; and
controlling the second electronic device for execution of the one or more commands, wherein the control involves at least one of: managing one or more functionalities of the second electronic device, overlaying one or more instruction elements on the feed, or overlaying a reaction of the instructor on the feed, wherein the one or more instruction elements direct the executor to perform one or more actions in the real-world location.

In a second aspect, the present disclosure provides a first electronic device for remotely directing an executor to perform actions, the first electronic device comprising:
a processor operable to:
establish a connection between the first electronic device associated with an instructor and a second electronic device associated with the executor, wherein the connection enables rendering a stream on the first electronic device, and wherein the rendering is based on a feed of a real-world location that is captured by a camera of the second electronic device and rendered on the second electronic device;
render a first user interface on the first electronic device, wherein the first user interface includes a first set of user interface elements overlaid on the stream rendered on the first electronic device, wherein the first set of user interface elements enables the instructor to control the second electronic device;
generate one or more commands based on capturing of one or more inputs from the instructor via the one or more user interface elements of the first set of user interface elements; and
control the second electronic device to at least one of: manage one or more functionalities of the second electronic device, overlay one or more instruction elements on the feed, or overlay a reaction of the instructor on the feed, wherein the second electronic device is controlled to direct the executor to perform one or more actions in the real-world location for execution of the one or more commands.

The present disclosure provides the aforementioned first aspect and the aforementioned second aspect to enable remote interaction and control of the executor's actions in real-time using the first electronic device (for example, a mobile phone, a tablet, a laptop, a PC (personal computer), a VR (Virtual Reality) device, an AR (Augmented Reality) device, and so on). The remote interaction and control may require synchronization of multimedia streams (which may be rendered on the first electronic device after transmission of the multimedia streams from the second electronic device), and transmission of events and commands (from the first electronic device to the second electronic device) over a communication network channel for facilitating a dynamic and responsive interaction. The aforementioned first and second aspects utilize virtual communication methods and systems for the streaming of the multimedia streams, and transmission of the events and the commands in real-time. For example, peer-to-peer (P2P) connections may be established between the first electronic device and the second electronic device, confidentiality of the established P2P connection may be ensured, and data transmission control protocols and data exchange tools may be used for interacting over circuit-switched and packet-switched networks.

The aforementioned first aspect and the aforementioned second aspect allow an instructor to observe the actions of the executor and direct the executor towards performing specific actions. The direction can be provided by use of software that facilitates rendering a user interface comprising user interface elements. The software generates commands that need to be executed based on inputs received through the user interface elements. Thus, the user interface elements offer various command options that range from simple movements (such as walking or turning) to complex actions (such as interacting with objects in a remote environment). The user interface may facilitate extended remote interaction between the instructor and the executer, interactive management of multimedia content, and allow the instructor to direct the executor to perform actions in real-time. Thus, the aforementioned first aspect and the aforementioned second aspect enables a deeper level of engagement by allowing the users to not only observe the executor, but also remotely influence and direct the actions of the executor, thereby expanding a wide range of possibilities for different application fields (such as remote collaboration, education, entertainment, and other fields) where real-time interaction is critical. Additionally, aforementioned first aspect and the aforementioned second aspect facilitate rendering another user interface that provides options to select an executor at a particular location from amongst a set of executors at various locations.

Initially, a connection is established between the first electronic device and the second electronic device. The first electronic device establishes the connection when an instructor associated with the first electronic device intends to connect with an executor who is associated with the second electronic device. The connection is established based on an intention of the instructor to avail a specific service from the executor. Availing the specific service involves directing the executor to perform one or more actions after the establishment of a direct communication between the instructor (i.e., the first electronic device) and the executor (i.e., the second electronic device). The executor may be directed based on inputs provided by the instructor via one or more user interface elements of the first set of user interface elements. The first set of user interface elements are included in the first user interface. The first user interface is rendered on the first electronic device.

In accordance with an embodiment, prior to the establishment of the connection, the instructor selects an executor from amongst a plurality of executors who are available to provide various types of services to instructors. Optionally, a second user interface may be rendered on the first electronic device. The second user interface includes a second set of user interface elements that are operable to receive a set of inputs, depict a set of executors available for selection, depict information associated with an executor who is selected from the set of executors and will be directed to perform one or more actions (to avail the service), depict a current state of charge of a battery of the second electronic device, and depict specifications associated with the second electronic device. The connection between the first electronic device and the second electronic device may be established based on the reception of the set of inputs.

Optionally, the set of inputs are indicative of a selection of the executor from a set of executors at a set of real-world locations, a selection of timings for a session, an instruction to start the session, a feedback about the session, and an instruction to perform a monetary transaction for initiating the session. The connection between the first electronic device and the second electronic device is sustained for a duration of the session.

The input indicative of selection of an executor from the set of executors may be received via a user interface element of the second set of user interface elements. The selection of the executor may be based on various criteria, including a location of the executor (such as a location of the second electronic device) and the skills of the executor to provide a particular type of service (such as a detailed exploration of historical sites, participation in cultural events, or receiving educational content that the instructor may require) that is of interest to the instructor. The location of the executor and the skill possessed by the executor may represent information associated with the executor (rendered on the second user interface). For example, if the user intents to explore a historical site at a certain location (such as “Red Square”), then user selects an executor who is located in Moscow (i.e., Moscow is the location of the second electronic device). The instructor directs the selected executor to perform the one or more actions so that the user is able to explore “Red Square”.

The set of inputs may further include an input (provided by the instructor) that enables the instructor to view a profile of the selected executor. The input may be received via another user interface element of the second set of user interface elements. The client may view an executor's profile prior to selecting the executor. Information included in the profile may represent the information associated with the executor. The profile may include one or more of a cost chargeable by the executor for providing a specific service for a certain amount of time, reviews provided by instructors who may have previously availed services from the executor, specifications of a device used by the executor (such as the second electronic device used by the (selected) executor), and a battery level (i.e., the state of charge) of the executor's device (such as the state of charge of the battery of the second electronic device).

After the selection of the executor, the instructor may authorize himself or herself as a transaction initiator and select a duration for which the connection with the executor may be established. The authorization and the selection of the duration may be performed by providing the input (via a user interface element of the second set of user interface elements) to perform a monetary transaction for initiating the session. Based on reception of the set of inputs via the second set of user interface elements, the connection is established between the first electronic device and the second electronic device. Optionally, the connection established between the first electronic device and the second electronic device is a Peer-to-Peer (P2P) connection. The connection is established upon reception of the input indicative of the instruction to start the session. The connection may be encrypted to ensure protection of personal data associated with the instructor and the executor.

In accordance with an embodiment, the connection established between the first electronic device and the second electronic device is a video session during which there is an exchange of multimedia content (i.e., audio and video). The second electronic device may receive a prompt (such as a call) which needs to be accepted. When the call is accepted (by the selected executor), the video session starts, and a stream is rendered on the first electronic device. The rendering of the stream is based on the feed of the real-world location (such as “Red Square”) that is captured by the camera of the second electronic device (which is located in Moscow). Optionally, the rendering of the stream on the first electronic device is based on reception of the feed transmitted by the second electronic device. The stream is a multimedia stream that is received by the first electronic device from the second electronic device and may include both audio content and video content.

Optionally, the reception of the feed by the first electronic device and the transmission of the feed by the second electronic device is carried out through Web Real-Time Communication (WebRTC) channels using Real-time Transport Protocol (RTP). In some embodiments, the transmission of the feed is carried out through Hyper-Text Transport Protocol version-2 (HTTP/2) or Quick User datagram protocol Internet Connections (QUIC) protocol. The stream captured by the camera is rendered on the second electronic device and the rendering on the second electronic device is synchronized with the rendering on the first electronic device. Optionally, the rendering of the stream on the first electronic device is synchronized with the rendering of the feed on the second electronic device. The synchronization of the renderings of the multimedia stream (i.e., the feed) at the first electronic device and the second electronic device may facilitate interactive interactions between the instructor and the executor.

Optionally, at least one of a frame-rate, a maximum bit-rate, and a minimum bit-rate of the rendered stream (i.e., the stream rendered on the first electronic device) is adjusted based on one or more of bandwidth, latency, and packet-loss associated with the connection established the first electronic device and the second electronic device. In accordance with an embodiment, a network connection monitoring system in the first electronic device may monitor the bandwidth, latency, and packet-loss associated with the connection. If the bandwidth is determined to be low (limited), then the frame rate of transmission (at the second electronic device) is reduced for preserving a resolution of the rendered stream. On the other hand, when the bandwidth reaches expected levels, the frame rate can be increased. This allows maintaining the quality of the stream irrespective of changes in network conditions. For example, when the bandwidth is low, the frame rate is decreased to 1 fps (frame per second) or 2 fps with a bit-rate of about 500 kbps (kilobits per second). When the bandwidth is moderate, the frame rate can be 5 fps, and the bit-rate can be 1 Mbps (megabits per second). When the bandwidth is moderate, the frame rate can be increased to 15 fps with the bit-rate of 10 Mbps or 30 fps with the bit-rate of 50 Mbps.

After the establishment of the connection and the rendering of the stream, the first user interface is rendered on the first electronic device. The first user interface includes the first set of user interface elements which are overlaid on the stream rendered on the first electronic device. The first set of user interface elements are operable to receive one or more inputs from the instructor. Optionally, the one or more inputs comprises a touch input, a gesture input, or a voice input. The one or more inputs of the instructor, received via one or more user interface elements of the first set of user interface elements, may be indicative of one or more actions that the instructor may be expecting the executor to perform. Thus, the first set of user interface elements enables the instructor to control the second electronic device (i.e., the executor). Optionally, the executor is one of a human or a robot. The executor may function as an avatar of the instructor at a remote location (such as “Red Square” in Moscow) who carries out the one or more actions to provide the service (i.e., perform one or more actions intended by the instructor).

Optionally, the first set of user interface elements comprises a first user interface element that indicates a duration of the connection, a second user interface element that indicates the current state of charge of the battery of the second electronic device, a third user interface element that is operable to receive an input to terminate the connection, a fourth user interface element that is operable to receive an input to record the feed rendered on the second electronic device, a fifth user interface element that is operable to receive an input to control a speaker of the second electronic device, and a sixth user interface element that is operable to receive an input to transmit an emoji to the second electronic device. The emoji is required to be overlaid on the feed rendered on the second electronic device.

The first set of user interface elements further comprises a seventh user interface element that is operable to receive an input to retrieve location information of the second electronic device. The location information is retrieved by accessing a map application that is installed on the second electronic device. The first set of user interface elements further comprises an eighth user interface element that is operable to receive an input to control a field-of-view of the camera of the second electronic device and a ninth user interface element operable to receive an input to direct the executor to rotate the second electronic device towards a certain direction by a certain angle.

The first set of user interface elements further comprises a tenth user interface element and an eleventh user interface element. Each of the tenth user interface element and the eleventh user interface element is operable to receive an input to control an orientation of the second electronic device. The first set of user interface elements further comprises a twelfth user interface element that is operable to receive an input to direct the executer to physically move towards a certain direction and a thirteenth user interface element operable to receive a voice input to control the second electronic device.

Optionally, the first user interface is a customizable user interface. The first set of user interface elements includes those user interface elements that have been selected by the instructor from a list of user interface elements. In accordance with an embodiment, an option is provided to the instructor to customize the first user interface such that the first set of user interface elements may include all of the thirteen user interface elements, or a subset of user interface elements that is selected by the instructor from amongst the first set of user interface elements (i.e., the thirteen user interface elements).

The first user interface element indicates a status of a counter that may be initialized at an instant of initiation of the rendering of the stream on the first electronic device. The status of a counter is indicative of the duration for which the rendering of the stream has been ongoing. The second user interface element indicates the state of charge of the battery of the second electronic device. Based on the indications, the instructor may decide whether to continue the rendering of the stream and/or the connection. The decision is influenced by a financial cost of engaging the executor which may increase with respect to the duration. The decision is also influenced by the state of charge since a lower state of charge may require terminating the connection. If the instructor decides to terminate the connection, the instructor may provide an input (a touch input) that is received by the third user interface element. Upon reception of the input via the third user interface element, the connection is terminated (and the rendering of the stream is stopped). At this instant, the video session is terminated. At this instant, the input of the set of inputs may be provided, via user interface elements of the second user interface, for providing feedback about the video session.

During the rendering of the stream, the instructor may decide to record the stream. For recording the stream, the instructor provides an input (a touch input) that is received by the fourth user interface element. Upon reception of the input, the recording of the stream may be initiated. Furthermore, if the instructor intends to control the speaker of the second electronic device, the instructor may provide an input (a touch input) that is received by the fifth user interface element. Upon reception of the input, the speaker is controlled to mute the speaker and increase or decrease one or more of volume, bass, treble, and so on, of the audio of the feed rendered on the second electronic device.

When the instructor intends to transmit an emoji to the second electronic device, the instructor provides an input (a touch input) that is received by the sixth user interface element. Upon reception of the input, the emoji may be transmitted to the second electronic device for it to be overlaid on the feed rendered on the second electronic device. When the instructor intends to determine a geolocation of the executor (i.e., the second electronic device), the instructor may provide an input (a touch input) that is received by the seventh user interface element. Upon reception of the input, the first electronic device may access the map application that is installed on the second electronic device and retrieve the location information associated with the second electronic device. After the retrieval, the geolocation of the executor may be indicated on a map application installed on the first electronic device. When the instructor intends to control the field-of-view of the camera of the second electronic device, the instructor provides an input (a touch input) that is received by the eighth user interface element. Upon reception of the input, the field-of-view of the camera of the second electronic device is controlled. The field-of-view is increased or decreased by zooming-out and zooming-in, respectively.

When the instructor intends to direct the executor to rotate the second electronic device towards a direction (for example, along the pitch or yaw directions) by a specified degree (for example, by a certain pitch angle or a certain yaw angle), the instructor may provide an input (a touch input) that is received by the ninth user interface element. The instructor may specify the degree by pressing, for a certain period, a portion of a display of the first electronic device where the ninth user interface element is rendered. Based on the reception of the input via the ninth user interface element, a user interface element is rendered on the first electronic device. The user interface element may indicate the specific degree by which the second electronic device is required to be rotated by the executor. A degree indicated in the user interface element increases from “0 ” degrees to the specific degree while a pressure is detected in the portion of the display where the ninth user interface element is rendered. The instructor may view the degree of the pitch or yaw angle and if the indicated angle is as intended by the instructor, the instructor may discontinue pressing the portion of the display. When the pressing is discontinued, the reception of the input is complete. Upon reception of the input, an instruction element is rendered on the second electronic device. The instruction element directs the executor to rotate the second electronic device towards the direction by the specified angle.

When the instructor intends to control the orientation of the second electronic device, the instructor may provide an input that may be received by the tenth user interface element or the eleventh user interface element. If the input is received via the tenth user interface element, a display of the first electronic device is activated to receive a touch input. For providing the touch input, the instructor may touch a portion of the display of the first electronic device. The touched portion corresponds to a region of the real-world location captured by the camera of the second electronic device (and included in the feed rendered on the second electronic device). Upon reception of the input, the first electronic device determines a current orientation and a differential orientation. The differential orientation is such that changing the current orientation of the second electronic device to an extent equal to the differential orientation may cause the second electronic device to orient towards the region of the real-world location. Thereafter, an instruction element is rendered on the second electronic device. The instruction element directs the executor to change the orientation by a certain degree (i.e., of a yaw angle and/or a pitch angle) to cause the second electronic device to orient towards the region of the real-world location.

On the other hand, if the input is received via the eleventh user interface element, the first electronic device is ready to detect a gesture input. In some embodiments, the gesture input involves physical movements on the part of the instructor. The movements are detected by a camera of the first electronic device and/or motion detection technology. The first electronic device may be ready to detect the gesture input after receiving a touch input via the eleventh user interface element. Based on the detected gesture input, an instruction element is rendered on the second electronic device. The instruction element directs the executor to change the orientation by a certain angle. It is to be noted that the instruction element may also direct the executor to perform other actions such as rotating the second electronic device or moving towards a certain direction. Furthermore, based on the detected gesture input, the one or more functionalities of the second electronic device may be controlled.

When the instructor intends to direct the executor to physically move towards a certain direction, the instructor may provide an input (a touch input) that is received by the twelfth user interface element. Upon reception of the input, an instruction element is rendered on the second electronic device. The instruction element may indicate the executor to physically move towards a direction that is intended by the instructor.

When the instructor intends to control the second electronic device by managing one or more functionalities of the second electronic device or overlaying one or more instruction elements on the feed, the instructor may provide a voice input. The voice input is received after receiving a touch input via the thirteenth user interface element. For example, the voice input may be “Mute the speaker (of the second electronic device)”, “terminate the session”, “rotate by 30 degrees (yaw angle)”, “move forward”, and so on. The one or more functionalities of the second electronic device are managed or the one or more instruction elements are overlayed after the reception of the voice input.

Thus, the first set of user interface elements enable the instructor to view a status of the connection (such as duration of the connection), a state of the second electronic device (such as the state of charge), and manage the connection (i.e., terminate the connection). Furthermore, the first set of user interface elements may enable the instructor to control the second electronic device (such as speaker, camera, and orientation of the second electronic device) either directly or by instructing the executor (through overlaying of instruction elements on the feed rendered on the second electronic device). Based on the reception of the one or more inputs from the instructor, via the one or more user interface elements of the first set of user interface elements, one or more commands are generated. For execution of the one or more commands, the second electronic device is controlled. The control involves managing the one or more functionalities (such as the speaker, the camera, and one or more location sensors for retrieval of location information) of the second electronic device, overlaying one or more instruction elements on the feed rendered on the second electronic device, and overlaying a reaction (such as an emoji that is indicative of the reaction) of the instructor on the feed. The one or more instruction elements are overlaid for directing the executor to perform actions of rotating the second electronic device, changing the orientation of the second electronic device, and physically moving towards a certain direction (such as front, back, left or right).

Optionally, the one or more commands are generated based on reception of the one or more inputs from the instructor via one or more of the third user interface element, the fourth user interface element, the fifth user interface element, the seventh user interface element, the eighth user interface element, the ninth user interface element, the tenth user interface element, the eleventh user interface element, the twelfth user interface element, and the thirteenth user interface element. The second electronic device is controlled for the execution of the one or more commands by managing the one or more functionalities of the second electronic device and overlaying one or more instruction elements on the feed rendered on the second electronic device.

Optionally, the one or more functionalities of the second electronic device include a screen-recorder controlled based on the input received via the fourth user interface element, the speaker controlled based on the input received via the fifth user interface element, a location sensor controlled based on the input received via the seventh user interface element, and the camera controlled based on the input received via the eighth user interface element. The one or more functionalities may be managed for controlling the second electronic device for execution of the one or more commands. The screen-recorder is controlled to record the stream or feed synchronously rendered on the first electronic device and the second electronic device. The speaker is controlled to enable or disable audio content of the feed rendered on the second electronic device. The location sensor controlled to retrieve location information of the second electronic device. The camera is controlled to increase or decrease the field-of-view of the camera.

Optionally, the one or more instruction elements overlaid on the feed include a first instruction element. The first instruction element is overlaid based on reception of the input via the ninth user interface element, the tenth user interface element, the eleventh user interface, or the thirteenth user interface element. The first instruction element instructs the executor to perform an action of rotating the second electronic device. The one or more instruction elements overlaid on the feed further include a second instruction element. The second instruction element is overlaid based on reception of the input via the twelfth user interface element. The second instruction element instructs the executor to perform a physical action of moving towards a certain direction. The first instruction element or the second instruction element is overlaid at a certain instant for controlling the second electronic device for executing a command. The first instruction element is rendered to instruct the user to perform the action of rotating the camera by a certain yaw angle and/or pitch angle. The second instruction element is rendered to instruct the user to perform the action of moving towards a certain direction as required for the execution of a command.

Optionally, the reaction of the instructor is overlaid on the feed based on reception of the input via the sixth user interface element. The second electronic device is controlled to overlay the reaction of the instructor on the feed when the input is received via the sixth user interface element overlaid on the stream (rendered on the first electronic device). The reaction is the emoji that the instructor had selected for transmission to the second electronic device for overlaying on the feed.

Optionally, the reception of the one or more inputs via the one or more user interface elements and the overlaying of the one or more instruction elements or the reaction on the feed is synchronized. Furthermore, the reception of the one or more inputs via the one or more user interface elements and managing of the one or more functionalities of the second electronic device is synchronized. It is to be noted that the reception of the one or more inputs via the one or more user interface elements of the first set of user interface elements and the controlling of the second electronic device (i.e., managing the one or more functionalities of the second electronic device, overlaying the one or more instruction elements on the feed rendered on the second electronic device, and overlaying the reaction on the feed) are synchronized. Thus, the reception of the one or more inputs and the controlling of the second electronic device takes place at (nearly) same instant. The synchronization facilitates interactive interaction the instructor and the executor.

Optionally, at a first instant, information indicating a current state of the second electronic device is received from the second electronic device. Thereafter, a partial execution of the one or more commands is detected based on a determination of a match between the current state and an intermediate expected state. Upon detection of the partial execution, the second electronic device is controlled to dynamically update the one or more instruction elements overlaid on the feed. At a second instant, information indicating the current state of the second electronic device is received from the second electronic device. Thereafter, a complete execution of the one or more commands is detected based on a determination of a match between the current state and a final expected state. The second electronic device is detected to be in the final expected state based on a performance of the one or more actions by the executor. Upon detection of complete execution, the second electronic device is controlled to remove the one or more instruction elements overlaid on the feed.

In an embodiment, the current state of the second electronic device may be a current orientation of the second electronic device. The current state of the second electronic device may be received (at the first instant) after an instruction element is overlaid on the feed rendered on the second electronic device. The instruction element may be overlaid for execution of a command to change the orientation of the second electronic device (on reception of an input via the tenth user interface element). The executor is directed to change the orientation of the second electronic device as per the instruction element. If the executor performs an action leading to the change in the orientation, the current state of the second electronic device may be received (at the first instance). Upon reception of the current orientation, the current orientation is compared with a final expected orientation. Based on the comparison it is determined that the current orientation is equal to an intermediate expected orientation. This may indicate that the command to change the orientation of the second electronic device has been partially executed.

Thereafter, based on the determination, the second electronic device is controlled to overlay an updated instruction element on the feed rendered on the second electronic device. The updated instruction element may indicate an extent to which the orientation of the second electronic device is required to be changed for execution of the command (such that the current orientation becomes equal to the final expected orientation). At the second instant, the current state of the second electronic device may be received again. The current state of the second electronic device is received upon the performance of an action by the executor (after the updated instruction element is overlaid on the feed) that leads to the change in the orientation to the current orientation. Upon reception of the current orientation, the current orientation is compared with a final expected orientation. Based on the comparison it may be determined that the current orientation is equal to (i.e., matching) the final expected orientation. This indicates that the execution of the command has been completed. Thereafter, the second electronic device is controlled to remove the updated instruction element overlaid on the feed.

Optionally, the one or more commands (generated based on reception of the one or more inputs from the instructor via the one or more user interface elements) comprises a command to rotate the second electronic device by a first angle. The one or more instruction elements overlaid on the feed includes an instruction element indicating that the second electronic device is required to be rotated by the first angle. The partial execution of the command is detected when the current state indicates that the second electronic device has been rotated by a second angle that is less than the first angle. The instruction element is updated based on the partial execution. The updated instruction element is overlaid on the feed to indicate that the second electronic device is required to be rotated by an angle that is a difference between the first angle and the second angle. The complete execution of the command is detected when the current state of the second electronic device indicates that the second electronic device has been rotated by the first angle. The updated instruction element is removed based on the detection of the complete execution.

For example, the command may be generated based on reception of an input via the ninth user interface element of the first set of user interface elements. For execution of the command, an instruction element, overlaid on the feed rendered on the second electronic device, may instruct the executor that the second electronic device is required to be rotated by 60 degrees in the yaw direction. The first electronic device may receive, at the first instant, a current state of the second electronic device. Based on the received status, it is determined that the second electronic device has been rotated by 40 degrees and that the command has been partially executed. Upon determination of partial execution of the command, the instruction element is updated. The updated instruction element indicates that the second electronic device is required to be rotated by 20 degrees in the yaw direction. The first electronic device may receive, at the second instant, the current state of the second electronic device. Based on the received status, it is determined that the second electronic device has been rotated by 20 degrees and that the execution of the command has been completed. The updated instruction element is removed based on determination of completion of the execution.

Optionally, a machine learning model is applied on the stream rendered on the first electronic device for detection of predefined objects of interest in one or more frames of the stream. A command based on an output of the machine learning model. The execution of the command requires at least one of overlaying an instruction element on the feed or managing a functionality of the second electronic device. The second electronic device is controlled for enabling execution of the command. The second electronic device is controlled to direct the executor to follow an instruction as indicated in the instruction element or manage the functionality for execution of the command.

In accordance with an embodiment, the machine learning model is trained to detect the predefine objects of interest. The machine learning model is stored in a memory of the first electronic device. The objects of interest may be those towards which the instructor may intend the camera of the second electronic device to focus or orient. The rendering of the stream on the first electronic device is based on the feed of the real-world location captured by the camera of the second electronic device. The objects of interest in the real-world location may be captured by the camera and rendered on the first electronic device when the stream is rendered on the first electronic device. The machine learning model may recognize or detect one or more objects of interest when the rendered stream is fed as an input to the first electronic device. The detected one or more objects of interest are the output of the machine learning model. Based on the output, a command may be generated. For execution of the command, the second electronic device is controlled. For example, if the command is an instruction that is meant to direct the executor to perform an action of rotating the second electronic device such that the camera orients towards a detected object of interest, then an instruction element is overlaid on the second electronic device. The instruction element may indicate that the second electronic device needs to be rotated by a certain angle. If the executor performs the action of rotating the second electronic device, then the camera orients towards the detected object of interest.

The present disclosure also relates to the second aspect as described above. Various embodiments and variants disclosed above, with respect to the aforementioned first aspect, apply mutatis mutandis to the second aspect.

The aforementioned first aspect and the aforementioned second aspect enable remote interaction and control of executors'actions in real-time using electronic devices (such as the first electronic device) through the transmission and synchronization of multimedia streams, transmission of commands to manage functionalities of the executors'electronic devices (such as the second electronic device), and transmission of instruction elements to direct the executors to perform actions. The transmissions can take place using various communication network channels. Thus, the aforementioned first aspect and the aforementioned second aspect offer means to overcome geographical and physical barriers, thereby providing opportunities for users to explore, learn, and communicate without limitations. This promotes cultural exchange and mutual understanding between people from different parts of the world, enriches their life experiences and broadens their horizons. Furthermore, it provides new opportunities for education, allowing students and researchers to virtually visit places that were previously inaccessible due to financial or physical constraints. Ultimately, both aforementioned first and second aspects may contribute to the creation of an open and interconnected world where knowledge and cultural heritage become accessible to anyone seeking new discoveries and experiences.

The aforementioned first aspect and the aforementioned second aspect allow instructors to remotely manage the different functionalities of the executors'devices (for example, change orientation of the devices, rotate the devices, expand or reduce field-of-view of cameras, and so on) in (near) real-time. This capability is based on an interaction between the software on the instructors'devices and the executors'devices, which is facilitated by high-performance data processing and faster transmission of instruction elements and commands (for controlling the functionalities) over the Internet. There is minimal delay between reception of inputs (from the instructor via user interface elements) and execution of the commands generated based on the inputs. This is critical for creating an immediate presence/control over exploration or observation processes.

The aforementioned first aspect and the aforementioned second aspect may be used in a wide range of applications across different industries and implemented to solve numerous practical tasks, including meeting requirements of various groups of people (such as bloggers, students, travelers, individuals with limited mobility, persons with disabilities). Specific examples of implementation may include the following areas:

Virtual tours and tourism: The method and the first electronic device may allow users (i.e., instructors) to select an executor on a map of a real-word location and remotely manage the executor during a virtual tour of a global museum or a historical site. The users can interact with and manage the actions of guides (i.e., executors) in real-time.

Educational Programs: The method and the first electronic device allow educational institutions, teachers, and students to organize and conduct remote lessons, research, laboratory work, and other activities through ensured remote interaction.

Charity: The method and the first electronic device allow users (i.e., instructors) to select executors and remotely manage the executors by directing them to stores to purchase food for homeless people or children and view results of their donation instantly on their devices (such as the first electronic device) and provide real-time feedback (through emojis).

Journalism and event reporting: The method and the first electronic device allow journalists (i.e., instructors) to present live reports from different locations by managing the actions of executors at the locations.

The journalists direct the executors to interact with people at the locations and record reports for subsequent analysis and publication. This allows live coverage of political or cultural events, where viewers can ask questions and receive answers in real-time.

Remote product purchases: The method and the first electronic device allow a user (i.e., an instructor) to remotely purchase products of various categories by directing the executor to enter a store, view, and select a product based on specific characteristics such as size, color, and so on, buy the product, and deliver the product to an intended location.

Property viewing: The method and the first electronic device allow real estate agencies to conduct remote property inspections virtual property tours for their clients. The clients (i.e., instructors) may remotely manage a guide or an agent (i.e., executors) to explore different aspects of the property. This enables clients to obtain information about the property's characteristics.

Technical support and remote service: The method and the first electronic device allow organizations and firms to provide technical support services to customers, whereby specialists can remotely diagnose and fix issues that users may be facing. The services may include remote equipment support, diagnosis, troubleshooting, and fixing equipment-related issues. This allows improving the quality of customer service/support.

### DETAILED DESCRIPTION OF THE DRAWINGS

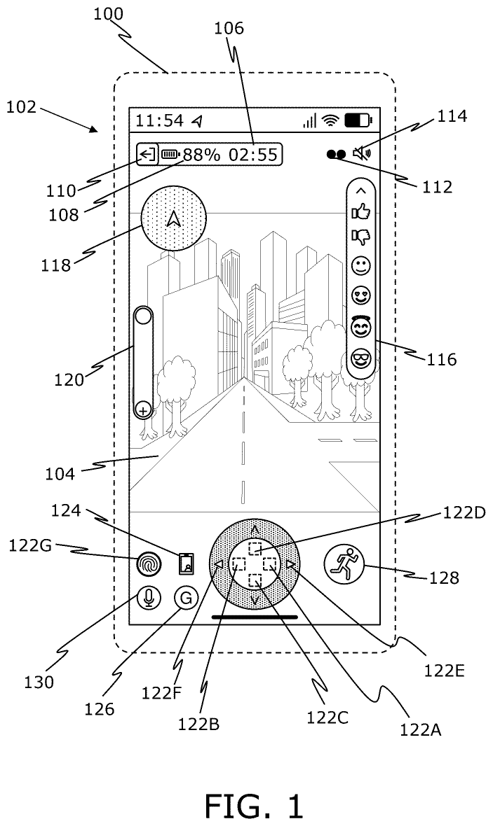

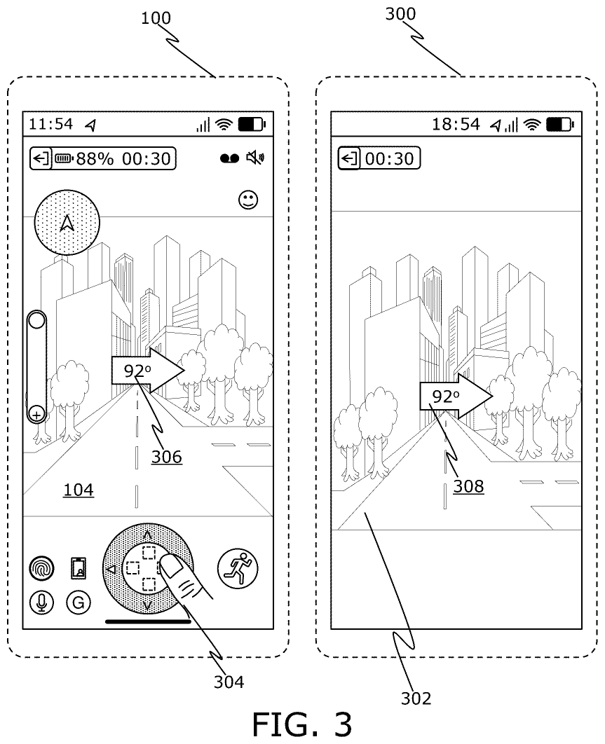

Referring to FIG. 1, there is illustrated a first electronic device 100 on which a first user interface 102 is rendered for remotely directing an executor to perform actions, in accordance with an embodiment of the present disclosure. The first user interface 102 is rendered on a display of the first electronic device 100 after establishment of a connection between the first electronic device 100 and a second electronic device (not shown). The rendering of the first user interface 102 may involve overlaying a first set of user interface elements on a stream 104 rendered on the display of the first electronic device 100. The rendering of the stream 104 on the first electronic device 100 is based on a feed of a real-world location captured by a camera of the second electronic device (see FIG. 3). In accordance with an embodiment, the rendering of the feed on the second electronic device is synchronized with the rendering of the stream on the first electronic device 100.

The first set of user interface elements comprises a first user interface element 106 that indicates a duration of the connection, a second user interface element 108 that indicates the current state of charge of the battery of the second electronic device, a third user interface element 110 that is operable to receive an input to terminate the connection, a fourth user interface element 112 that is operable to receive an input to record the feed rendered on the second electronic device, and a fifth user interface element 114 that is operable to receive an input to control a speaker of the second electronic device.

The first set of user interface elements further comprises a sixth user interface element 116 that is operable to receive an input to transmit an emoji to the second electronic device. The emoji is to be overlaid on the feed rendered on the second electronic device. The first set of user interface elements further comprises a seventh user interface element 118 that is operable to receive an input to retrieve location information of the second electronic device. The location information is retrieved by accessing a map application installed on the second electronic device. The first set of user interface elements further comprises an eighth user interface element 120 that is operable to receive an input to control a field-of-view of the camera of the second electronic device, and a ninth user interface element (122A, 122B, 122C, 122D, 122E, 122F) that is operable to receive an input to direct the executor to rotate the second electronic device towards a certain direction by a certain angle. The input is received after reception of an input via a user interface element 122G.

The first set of user interface elements further comprises a tenth user interface element 124 and an eleventh user interface element 126. Each of the tenth user interface element 124 and the eleventh user interface 126 element are operable to receive an input to control an orientation of the second electronic device. If the input is received via the tenth user interface element 124, then the display of the first electronic device 100 is activated for receiving a touch input. Based on the touch input, an orientation of the second electronic device may be controlled. If the input is received via the eleventh user interface element 126, then the first electronic device 100 is operable to receive a gesture input. Based on the gesture input, an orientation of the second electronic device may be controlled. The first set of user interface elements further comprises a twelfth user interface element 128 that is operable to receive an input to direct the executor to physically move towards a certain direction, and a thirteenth user interface element 130 operable to receive a voice input to control the second electronic device.

FIG. 1 is merely an example, which should not unduly limit the scope of the claims herein. A person skilled in the art will recognize many variations, alternatives, and modifications of embodiments of the present disclosure. For example, the first set of user interface elements may include some or all of the illustrated user interface elements.

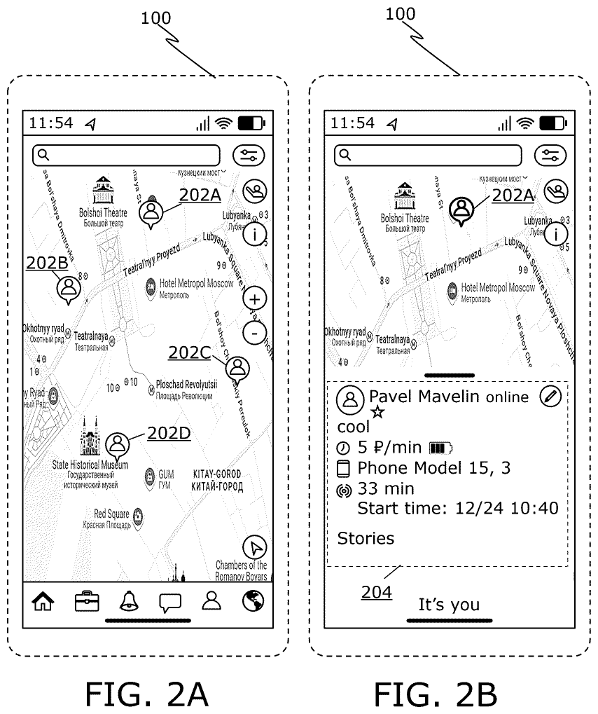

Referring to FIGS. 2A and 2B, there are illustrated a rendering of a second user interface 200 on the first electronic device 100 at different instances, in accordance with an embodiment of the present disclosure. The second user interface 200 is rendered on the display prior to the establishment of the connection between the first electronic device 100 and the second electronic device. The second user interface 200 includes a second set of user interface elements that are operable to receive a set of inputs. As illustrated in FIG. 2A, at a first instant, the second user interface 200 renders a map of a real-world location (for example, central Moscow). The map depicts a set of executors available for selection. The set of executors can provide various types of services to instructors. The set of executors are represented as user interface elements 202A-202D of the second set of user interface elements rendered on the first electronic device 100. An instructor associated with the first electronic device 100 may select an executor of the set of executors by providing a touch input. The selection of the executor may be based on criteria such as location of the executor (i.e., location of the second electronic device) and skills of the executor to provide a particular type of service that is of interest to the instructor. The touch input, provided by the instructor, is received via the user interface element 202A.

Upon reception of the touch input, at a second instant, a user interface element 204 of the second set of user interface elements is rendered. As illustrated in FIG. 2B, the user interface element 204 depicts the selected executor and information (such as executor name and ratings) associated with the selected executor. The selected executor is directed to perform one or more actions for execution of a command received from the instructor. The command is received via user interface elements of the first set of user elements (see FIG. 1) after the connection is established between the first electronic device 100 and the second electronic device. Additionally, the user interface element 204 may depict a current state of charge of a battery of the second electronic device (associated with the selected executor), specifications (such as phone model number) associated with the second electronic device, an instant of initiation of a video session, a period for which the video session will sustain, and an amount chargeable for availing the services of the executor.

FIG. 2 is merely an example, which should not unduly limit the scope of the claims herein. A person skilled in the art will recognize many variations, alternatives, and modifications of embodiments of the present disclosure.

Referring to FIG. 3, there is illustrated an exemplary controlling of a second electronic device 300 by the first electronic device 100 for execution of a command to rotate the second electronic device 300, in accordance with an embodiment of the present disclosure. The second electronic device 300 is controlled after the establishment of the connection between the first electronic device 100 and the second electronic device 300 has been completed. The connection is a video session during which there is an exchange of multimedia content. During the video session, the stream 104 is rendered on the display of the first electronic device 100. The rendering of the stream 104 is based on a feed 302 of a real-world location captured by a camera of the second electronic device 300 which is at the real-world location. The rendering of the stream 104 on the first electronic device 100 is based on reception of the feed 302 transmitted by the second electronic device 300. Furthermore, the rendering of the stream 104 on the first electronic device 100 is synchronized with the rendering of the feed 302 on the second electronic device 300.

The first set of user interface elements of the first user interface, (see FIG. 1) are overlaid on the stream 104. The first set of user interface elements are operable to receive one or more inputs from an instructor 304. The one or more inputs comprises a touch input, a gesture input, or a voice input. At any instant, a first touch input is received via the user element 122G. The reception of the first touch input activates the ninth user interface element (122A, 122B, 122C, 122D, 122E, 122F) to receive touch inputs. Thereafter, a second touch input is received via the ninth user interface element 122A. Upon reception of the second touch input, a user interface element 306 is rendered on the display of the first electronic device 100. The reception of the second touch input indicates that the instructor 304 intends to direct an executor, associated with the second electronic device 300, to rotate the second electronic device 300 by an angle of 92 degrees along yaw direction. The angle (92 degrees) is rendered on the user interface element 306. The rendering of the angle on the user interface element 306 is based on a detection of pressure on a portion of the display of the first electronic device 100 where the ninth user interface element 122A is rendered. The angle rendered on the user interface element 306 increases from 0 degrees to 92 degrees while the application of pressure on the portion of the display continues to be detected. When the pressure is no longer detected, the angle rendered on the user interface element 306 is 92 degrees along the yaw direction.

Upon reception of the second touch input, a command is generated. For execution of the command, the electronic device 300 is controlled. This involves transmitting an instruction element 308 and controlling a display of the second electronic device 300 to overlay the instruction element 308 on the feed 302 rendered on the second electronic device 300. The instruction element 308 may direct the executor to rotate the second electronic device 300 by 92 degrees along the yaw direction. It is to be noted that the reception of the second touch input and the overlaying of the instruction element 308 on the feed 302 is synchronized.

FIG. 3 is merely an example, which should not unduly limit the scope of the claims herein. A person skilled in the art will recognize many variations, alternatives, and modifications of embodiments of the present disclosure.

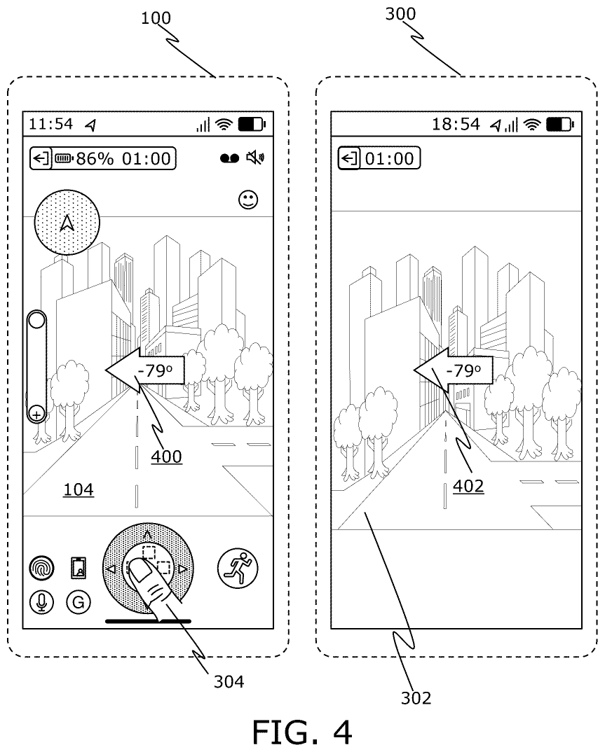

Referring to FIG. 4, there is illustrated an exemplary controlling of the second electronic device 300 by the first electronic device 100 for execution of a command to rotate the second electronic device 300, in accordance with an embodiment of the present disclosure. At any instant, a first touch input is received via the user element 122G. Thereafter, a second touch input is received via the ninth user interface element 122B. Upon reception of the second touch input, a user interface element 400 is rendered on the display of the first electronic device 100. The reception of the second touch input indicates that the instructor 304 intends to direct the executor to rotate the second electronic device 300 by an angle of −79 degrees along the yaw direction. The angle (−79 degrees) is rendered on the user interface element 400. The rendering of the angle on the user interface element 400 is based on a detection of pressure on a portion of the display of the first electronic device 100 where the ninth user interface element 122B is rendered. The angle rendered on the user interface element 306 varies from 0 degrees to −79 degrees while the application of pressure on the portion of the display continues to be detected. When the pressure is no longer detected, the angle rendered on the user interface element 400 is −79 degrees along the yaw direction.

Upon reception of the second touch input, a command is generated. For execution of the command, the electronic device 300 is controlled. This involves transmitting an instruction element 402 and controlling the display of the second electronic device 300 to overlay the instruction element 402 on the feed 302 rendered on the second electronic device 300. The instruction element 402 may direct the executor to rotate the second electronic device 300 by −79 degrees along the yaw direction. It is to be noted that the reception of the second touch input and the overlaying of the instruction element 402 is synchronized.

FIG. 4 is merely an example, which should not unduly limit the scope of the claims herein. A person skilled in the art will recognize many variations, alternatives, and modifications of embodiments of the present disclosure.

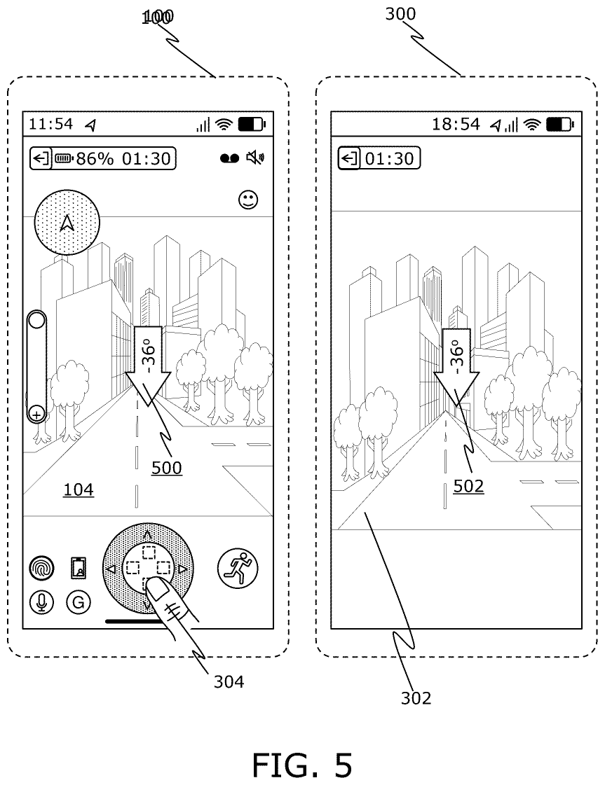

Referring to FIG. 5, there is illustrated an exemplary controlling of the second electronic device 300 by the first electronic device 100 for execution of a command to rotate the second electronic device 300, in accordance with an embodiment of the present disclosure. At any instant, a first touch input is received via the user element 122G. Thereafter, a second touch input is received via the ninth user interface element 122C. Upon reception of the second touch input, a user interface element 500 is rendered on the display of the first electronic device 100. The reception of the second touch input indicates that the instructor 304 intends to direct the executor to rotate the second electronic device 300 by an angle of −36 degrees along pitch direction. The angle (−36 degrees) is rendered on the user interface element 500. The rendering of the angle on the user interface element 500 is based on a detection of pressure on a portion of the display of the first electronic device 100 where the ninth user interface element 122C is rendered. The angle rendered on the user interface element 500 varies from 0 degrees to −36 degrees while the application of pressure on the portion of the display continues to be detected. When the pressure is no longer detected, the angle rendered on the user interface element 500 is −36 degrees along the pitch direction.

Upon reception of the second touch input, a command is generated. For execution of the command, the electronic device 300 is controlled. This involves transmitting an instruction element 502 and controlling the display of the second electronic device 300 to overlay the instruction element 502 on the feed 302 rendered on the second electronic device 300. The instruction element 502 may direct the executor to rotate the second electronic device 300 by −36 degrees along the pitch direction. It is to be noted that the reception of the second touch input and the overlaying of the instruction element 502 is synchronized.

FIG. 5 is merely an example, which should not unduly limit the scope of the claims herein. A person skilled in the art will recognize many variations, alternatives, and modifications of embodiments of the present disclosure.

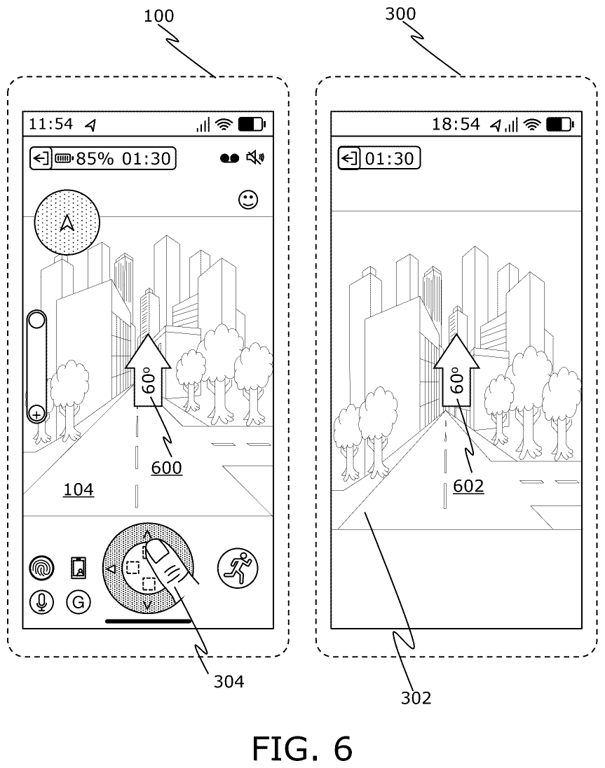

Referring to FIG. 6, there is illustrated an exemplary controlling of the second electronic device 300 by the first electronic device 100 for execution of a command to rotate the second electronic device 300, in accordance with an embodiment of the present disclosure. At any instant, a first touch input is received via the user element 122G. Thereafter, a second touch input is received via the ninth user interface element 122D. Upon reception of the second touch input, a user interface element 600 is rendered on the display of the first electronic device 100. The reception of the second touch input indicates that the instructor 304 intends to direct the executor to rotate the second electronic device 300 by an angle of 60 degrees along the pitch direction. The angle (60 degrees) is rendered on the user interface element 600. The rendering of the angle on the user interface element 600 is based on a detection of pressure on a portion of the display of the first electronic device 100 where the ninth user interface element 122D is rendered. The angle rendered on the user interface element 600 varies from 0 degrees to 60 degrees while the application of pressure on the portion of the display continues to be detected. When the pressure is no longer detected, the angle rendered on the user interface element 600 is 60 degrees along the pitch direction.

Upon reception of the second touch input, a command is generated. For execution of the command, the electronic device 300 is controlled. This involves transmitting an instruction element 602 and controlling the display of the second electronic device 300 to overlay the instruction element 602 on the feed 302 rendered on the second electronic device 300. The instruction element 602 may direct the executor to rotate the second electronic device 300 by 60 degrees along the pitch direction. It is to be noted that the reception of the second touch input and the overlaying of the instruction element 602 is synchronized.

FIG. 6 is merely an example, which should not unduly limit the scope of the claims herein. A person skilled in the art will recognize many variations, alternatives, and modifications of embodiments of the present disclosure.

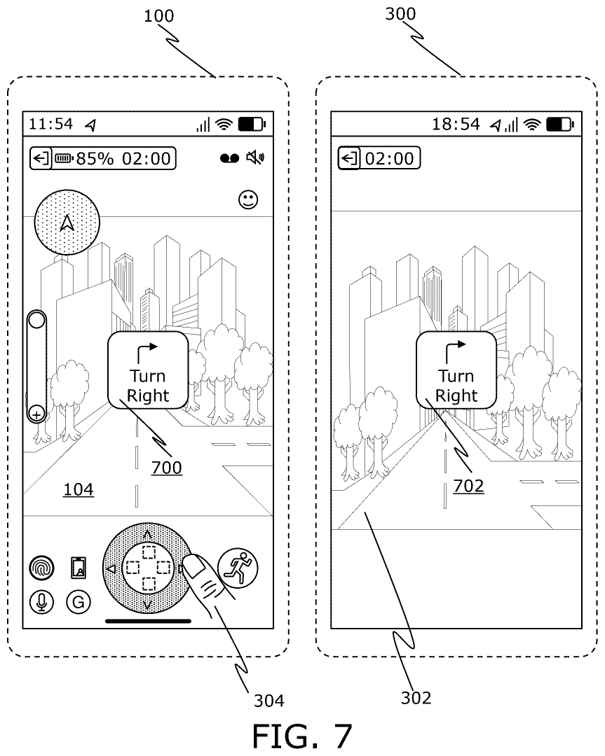

Referring to FIG. 7, there is illustrated an exemplary controlling of the second electronic device 300 by the first electronic device 100 for execution of a command to rotate the second electronic device 300, in accordance with an embodiment of the present disclosure. At any instant, a first touch input is received via the user element 122G. Thereafter, a second touch input is received via the ninth user interface element 122E. Upon reception of the second touch input, a user interface element 700 is rendered on the display of the first electronic device 100. The reception of the second touch input indicates that the instructor 304 intends to direct the executor to rotate the second electronic device 300 in the right direction (i.e., yaw direction) by an angle of 90 degrees. A pointer indicative of the right direction and a message “turn right” is rendered on the user interface element 700. The rendering of the user interface element 700 is based on a detection of pressure on a portion of the display of the first electronic device 100 where the ninth user interface element 122E is rendered.

Upon reception of the second touch input, a command is generated. For execution of the command, the electronic device 300 is controlled. This involves transmitting an instruction element 702 and controlling the display of the second electronic device 300 to overlay the instruction element 702 on the feed 302 rendered on the second electronic device 300. The instruction element 702 may direct the executor to rotate the second electronic device 300 in the right direction (i.e., yaw direction) by an angle of 90 degrees. It is to be noted that the reception of the second touch input and the overlaying of the instruction element 702 on the feed 302 is synchronized.

FIG. 7 is merely an example, which should not unduly limit the scope of the claims herein. A person skilled in the art will recognize many variations, alternatives, and modifications of embodiments of the present disclosure.

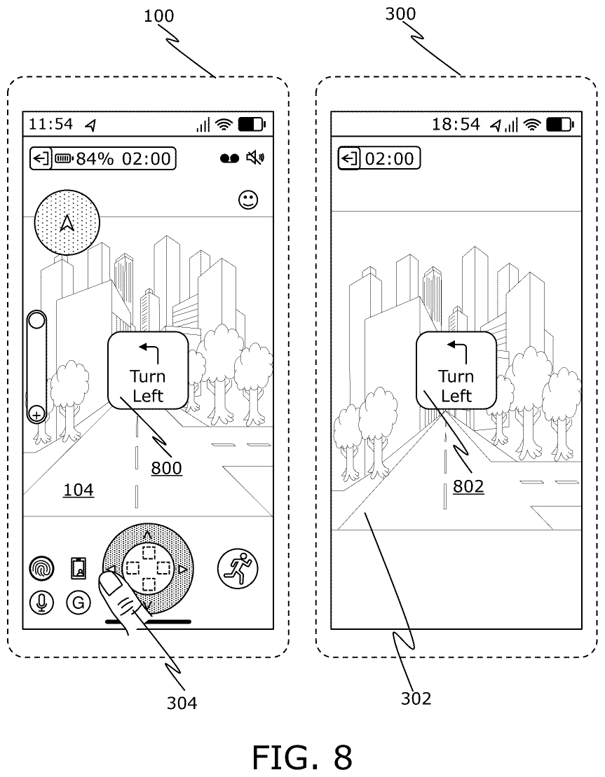

Referring to FIG. 8, there is illustrated an exemplary controlling of the second electronic device 300 by the first electronic device 100 for execution of a command to rotate the second electronic device 300, in accordance with an embodiment of the present disclosure. At any instant, a first touch input is received via the user element 122G. Thereafter, a second touch input is received via the ninth user interface element 122F. Upon reception of the second touch input, a user interface element 800 is rendered on the display of the first electronic device 100. The reception of the second touch input indicates that the instructor 304 intends to direct the executor to rotate the second electronic device 300 in the left direction (i.e., yaw direction) by an angle of −90 degrees. A pointer indicative of the left direction and a message “turn left” is rendered on the user interface element 800. The rendering of the user interface element 800 is based on a detection of pressure on a portion of the display of the first electronic device 100 where the ninth user interface element 122F is rendered.

Upon reception of the second touch input, a command is generated. For execution of the command, the electronic device 300 is controlled. This involves transmitting an instruction element 802 and controlling the display of the second electronic device 300 to overlay the instruction element 802 on the feed 302 rendered on the second electronic device 300. The instruction element 802 may direct the executor to rotate the second electronic device 300 in the left direction (i.e., yaw direction) by an angle of −90 degrees. It is to be noted that the reception of the second touch input and the overlaying of the instruction element 802 on the feed 302 is synchronized.

FIG. 8 is merely an example, which should not unduly limit the scope of the claims herein. A person skilled in the art will recognize many variations, alternatives, and modifications of embodiments of the present disclosure.

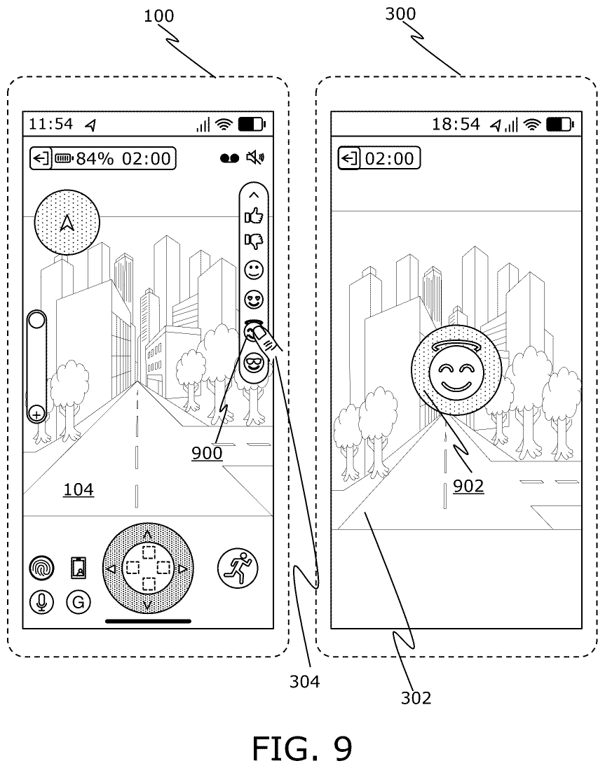

Referring to FIG. 9, there is illustrated an exemplary controlling of the second electronic device 300 by the first electronic device 100 for overlaying a reaction of the instructor 304 on the second electronic device 300, in accordance with an embodiment of the present disclosure. At any instant, the first electronic device 100 may receive a touch input via the sixth user interface element 116. The touch input is received when the instructor 304 intends to transmit an emoji 900 to the second electronic device 300. Upon reception of the touch input, a command is generated. For execution of the command the emoji 900 is required to be transmitted to the second electronic device 300 and overlaid on the feed 302 rendered on the second electronic device 300. The command is executed by controlling the display of the second electronic device 300. This includes overlaying a reaction 902 (i.e., the emoji 900 indicative of the reaction 902) of the instructor 304 on the feed 302 rendered on the second electronic device 300. It is to be noted that the reception of the touch input and the overlaying of the reaction 902 is synchronized.

FIG. 9 is merely an example, which should not unduly limit the scope of the claims herein. A person skilled in the art will recognize many variations, alternatives, and modifications of embodiments of the present disclosure.

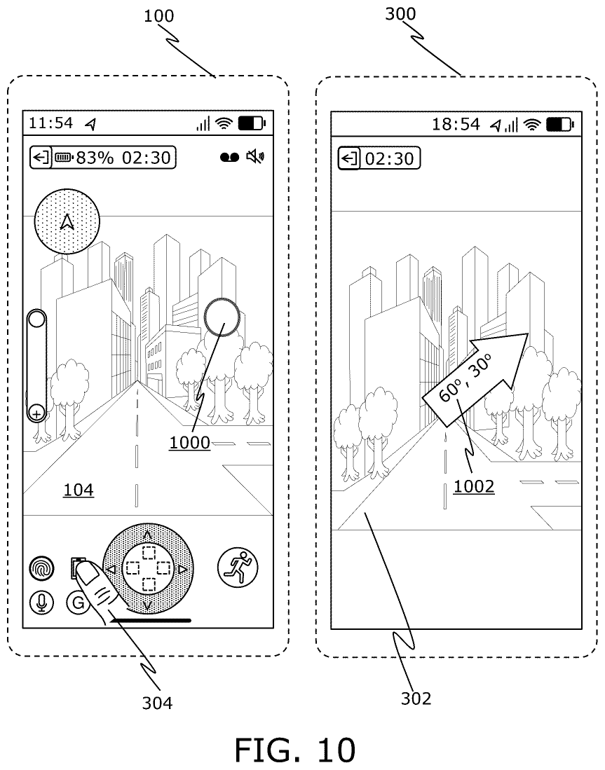

Referring to FIG. 10, there is illustrated an exemplary controlling of the second electronic device 300 by the first electronic device 100 for changing an orientation of the second electronic device 300, in accordance with an embodiment of the present disclosure. At any instant, a first touch input is received via the tenth user interface element 124. The reception of the first touch input activates the display of the first electronic device 100 for receiving a second touch input. The second touch input is received at a portion 1000 of the display. The portion 1000 corresponds to a region of the real-world location which is captured by a camera of the second electronic device 300 and included in the feed 302 rendered on the second electronic device 300. The reception of the second touch input indicates that the instructor 304 intends to direct the executor to change the current orientation of the second electronic device 300 by a certain yaw angle and a certain pitch angle such that the second electronic device 300 orients towards the real-world location. The yaw angle and the pitch angle are determined based on the current orientation of the second electronic device 300 and a differential orientation. The current orientation specifies a current yaw angle (0 degrees) and a current pitch angle (0 degrees) of the second electronic device 300 whereas the differential orientation specifies an extent to which the current yaw angle and the current pitch angle needs to be adjusted such that the second electronic device 300 orient towards the region of the real-world location. The differential orientation is determined as a yaw angle of 30 degrees and a pitch angle of 60 degrees.

After the reception of the second touch input and the determination of the differential orientation, a command is generated. For execution of the command, the electronic device 300 is controlled by transmitting an instruction element 1002 and controlling the display of the second electronic device 300 to overlay the instruction element 1002 on the feed 302 rendered on the second electronic device 300. The instruction element 1002 may direct the executor to rotate the second electronic device 300 by a yaw angle of 30 degrees and a pitch angle of 60 degrees.

FIG. 10 is merely an example, which should not unduly limit the scope of the claims herein. A person skilled in the art will recognize many variations, alternatives, and modifications of embodiments of the present disclosure.

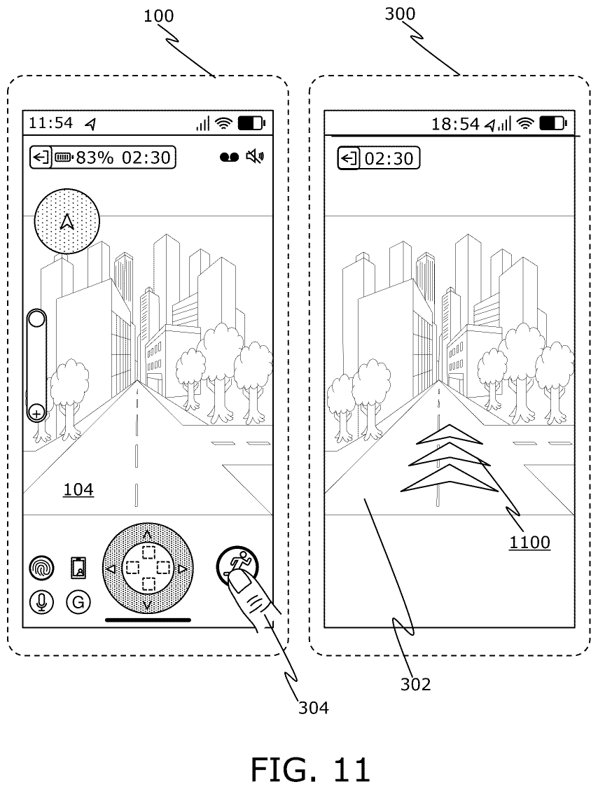

Referring to FIG. 11, there is illustrated an exemplary controlling of the second electronic device 300 by the first electronic device 100 for execution of a command to direct an executor to physically move towards a certain direction, in accordance with an embodiment of the present disclosure. At any instant, a touch input is received via the twelfth user interface element 128. The reception of the touch input indicates that the instructor 304 intends to direct the executor to physically move towards the forward direction. Upon reception of the touch input, a command is generated. For execution of the command, the electronic device 300 is controlled. This involves transmitting an instruction element 1100 and controlling the display of the second electronic device 300 to overlay the instruction element 1100 on the feed 302 rendered on the second electronic device 300. The instruction element 1100 may direct the executor to physically move towards the forward direction. It is to be noted that the reception of the touch input and the overlaying of the instruction element 1100 on the feed 302 is synchronized.

FIG. 11 is merely an example, which should not unduly limit the scope of the claims herein. A person skilled in the art will recognize many variations, alternatives, and modifications of embodiments of the present disclosure.

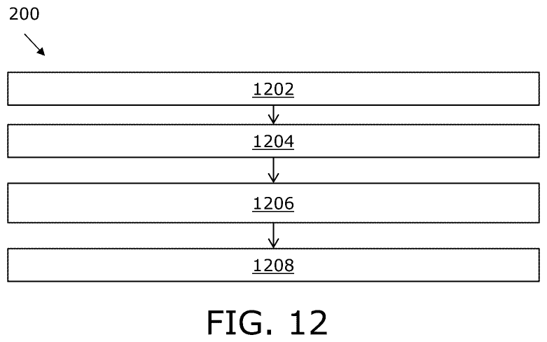

Referring to FIG. 12, depicted are steps of a method for remotely directing an executor to perform one or more actions, in accordance with an embodiment of the present disclosure. At step 1202, a connection is established between the first electronic device 100 and the second electronic device 300. The connection is established by the first electronic device 100. The first electronic device 100 is associated with the instructor 304. The second electronic device 300 is associated with the executor. The connection enables rendering a stream 104 on the first electronic device 100. The rendering of the stream 104 is based on the feed 302 of a real-world location that is captured by a camera of the second electronic device 300. The feed 302 is rendered on the second electronic device 300. At step 1204, a first user interface 102 is rendered on the first electronic device 100. The first user interface 102 includes a first set of user interface elements 106-130 overlaid on the stream 104 rendered on the first electronic device 100. The first set of user interface elements 106-130 enables the instructor 304 to control the second electronic device 300. At step 1206, one or more commands are generated based on reception of one or more inputs from the instructor 304 via the one or more user interface elements of the first set of user interface elements 106-130. At 1208, the second electronic device 300 is controlled for execution of the one or more commands. The control involves at least one of managing one or more functionalities of the second electronic device 300 overlaying one or more instruction elements 308, 402, 502, 602, 702, 802, 1002, 1100 on the feed 302, or overlaying the reaction 902 of the instructor on the feed 302. The one or more instruction elements 308, 402, 502, 602, 702, 802, 1002, 1100 direct the executor to perform one or more actions in the real-world location.

The aforementioned steps are only illustrative and other alternatives can also be provided where one or more steps are added, one or more steps are removed, or one or more steps are provided in a different sequence without departing from the scope of the claims herein.

1. A method for remotely directing an executor to perform actions, the method comprising:
establishing, by a first electronic device associated with an instructor, a connection with a second electronic device associated with the executor, wherein the connection enables rendering a stream on the first electronic device, and wherein the rendering is based on a feed of a real-world location that is captured by a camera of the second electronic device and rendered on the second electronic device;
rendering a first user interface on the first electronic device, wherein the first user interface includes a first set of user interface elements overlaid on the stream rendered on the first electronic device, wherein the first set of user interface elements enables the instructor to control the second electronic device;
generating one or more commands based on reception of one or more inputs from the instructor via the one or more user interface elements of the first set of user interface elements; and
controlling the second electronic device for execution of the one or more commands, wherein the control involves at least one of managing one or more functionalities of the second electronic device, overlaying one or more instruction elements on the feed, or overlaying a reaction of the instructor on the feed, wherein the one or more instruction elements direct the executor to perform one or more actions in the real-world location.

2. The method according to claim 1, wherein the rendering of the stream on the first electronic device is based on reception of the feed transmitted by the second electronic device, wherein the rendering of the stream on the first electronic device is synchronized with the rendering of the feed on the second electronic device, and wherein at least one of a frame-rate, a maximum bit-rate, and a minimum bit-rate of the rendered stream is adjusted based on one or more of bandwidth, latency, and packet-loss associated with the connection.

3. The method according to claims 1, wherein the connection established between the first electronic device and the second electronic device is a Peer-to-Peer (P2P) connection, and wherein the reception of the feed by the first electronic device and the transmission of the feed by the second electronic device is carried out using one of a Real-time Transport Protocol (RTP) through Web Real-Time Communication (RTC) channels, a Hyper-Text Transport Protocol version-2 (HTTP/2), or a Quick User datagram protocol Internet Connections (QUIC) protocol.

4. The method according to claim 1, wherein the executor is one of a human or a robot, and wherein the executor functions as an avatar of the instructor.

5. The method according to claim 1, wherein
the reception of the one or more inputs via the one or more user interface elements and the overlaying of the one or more instruction elements or the reaction on the feed is synchronized, and
the reception of the one or more inputs via the one or more user interface elements and the managing of the one or more functionalities of the second electronic device is synchronized.

6. The method according to claim 1, wherein the first set of user interface elements comprises:
a first user interface element that indicates a duration of the connection;
a second user interface element that indicates the current state of charge of the battery of the second electronic device;
a third user interface element that is operable to receive an input to terminate the connection;
a fourth user interface element that is operable to receive an input to record the feed rendered on the second electronic device;
a fifth user interface element that is operable to receive an input to control a speaker of the second electronic device;
a sixth user interface element that is operable to receive an input to transmit an emoji to the second electronic device, wherein the emoji is to be overlaid on the feed rendered on the second electronic device;
a seventh user interface element that is operable to receive an input to retrieve location information of the second electronic device, wherein the location information is retrieved by accessing a map application installed on the second electronic device;
an eighth user interface element that is operable to receive an input to control a field-of-view of the camera of the second electronic device;
a ninth user interface element that is operable to receive an input to direct the executor to rotate the second electronic device towards a certain direction by a certain angle;
a tenth user interface element and an eleventh user interface element, wherein each of the tenth user interface element and the eleventh user interface element is operable to receive an input to control an orientation of the second electronic device;
a twelfth user interface element operable to receive an input to direct the executor to physically move towards a certain direction; and
a thirteenth user interface element operable to receive a voice input to control the second electronic device.

7. The method according to claim 1,
wherein the one or more commands are generated based on reception of the one or more inputs from the instructor via one or more of the third user interface element, the fourth user interface element the fifth user interface element the seventh user interface element, the eighth user interface element, the ninth user interface element, the tenth user interface element the eleventh user interface element the twelfth user interface element, and the thirteenth user interface element;
wherein the one or more functionalities of the second electronic device include a screen-recorder controlled based on the input received via the fourth user interface element, the speaker controlled based on the input received via the fifth user interface element, a location sensor controlled based on the input received via the seventh user interface element, and the camera controlled based on the input received via the eighth user interface element;
wherein the one or more instruction elements overlaid on the feed include a first instruction element that directs the executor to perform an action of rotating the second electronic device, and a second instruction element that instructs the executor to perform an action of physically moving towards a direction;
wherein the first instruction element is overlaid based on reception of an input via one of the ninth user interface element, the tenth user interface element, the eleventh user interface, or the thirteenth user interface element;
wherein the second instruction element is overlaid based on reception of the input via the twelfth user interface element; and
wherein the reaction of the instructor is overlaid on the feed based on reception of the input via the sixth user interface element.

8. The method according to claim 1, wherein the method further comprises:
receiving, from the second electronic device at a first instant, information indicating a current state of the second electronic device;
detecting a partial execution of the one or more commands, wherein the detection is based on a determination of a match between the current state and an intermediate expected state;
controlling, upon detection of partial execution, the second electronic device to dynamically update the one or more instruction elements overlaid on the feed;
receiving, from the second electronic device at a second instant, information indicating the current state of the second electronic device;
detecting a complete execution of the one or more commands, wherein the detection is based on a determination of a match between the current state and a final expected state, wherein the second electronic device is detected to be in the final expected state based on a performance of the one or more actions by the executor; and
controlling, upon detection of complete execution, the second electronic device to remove the one or more instruction elements overlaid on the feed.

9. The method according to claim 1,
wherein the one or more commands comprises a command to rotate the second electronic device by a first angle;
wherein the one or more instruction elements overlaid on the feed includes an instruction element indicating that the second electronic device is required to be rotated by the first angle;
wherein the partial execution of the command is detected when the current state indicates that the second electronic device has been rotated by a second angle that is less than the first angle;
wherein the instruction element is updated based on the partial execution and an updated instruction element is overlaid on the feed to indicate that the second electronic device is required to be rotated by an angle that is a difference between the first angle and the second angle;
wherein the complete execution of the command is detected when the current state indicates that the second electronic device has been rotated by the first angle; and
wherein the updated instruction element is removed based on the detection of the complete execution.

10. The method according to claim 1, wherein captured one or more inputs comprises a touch input, a gesture input, or a voice input.

11. The method according to claim 1, wherein the method further comprises rendering a second user interface on the first electronic device,
wherein the second user interface includes a second set of user interface elements that are operable to receive a set of inputs, depict a set of executors available for selection, depict information associated with an executor who is selected from the set of executors and will be directed to perform the one or more actions, depict a current state of charge of a battery of the second electronic device, and depict specifications associated with the second electronic device, and
wherein the connection between the first electronic device and the second electronic device is established based on the reception of the set of inputs.

12. The method according claim 11, wherein the set of inputs are indicative of a selection of the executor from a set of executors at a set of real-world locations, a selection of timings for a session, an instruction to start the session, a feedback about the session, and an instruction to perform a monetary transaction for initiating the session, and wherein the connection between the first electronic device and the second electronic device is sustained for a duration of the session.

13. The method according to claim 1, wherein the method further comprises:
applying a machine learning model on the stream rendered on the first electronic device for detection of predefined objects of interest in one or more frames of the stream;
receive a command based on an output of the machine learning model, wherein execution of the command requires at least one of overlaying an instruction element on the feed or managing a functionality of the second electronic device; and
control the second electronic device for enabling execution of the command, wherein the second electronic device is controlled to direct the executor to follow an instruction as indicated in the instruction element or manage the functionality for execution of the command.

14. The method according to claim 1, wherein the first user interface is a customizable user interface, and wherein the first set of user interface elements includes those user interface elements that have been selected by the instructor from a list of user interface elements.

15. A first electronic device for remotely directing an executor to perform actions, the first electronic device comprising:
a processor operable to:
establish a connection between the first electronic device associated with an instructor and a second electronic device associated with the executor, wherein the connection enables rendering a stream on the first electronic device, and wherein the rendering is based on a feed of a real-world location that is captured by a camera of the second electronic device and rendered on the second electronic device;
render a first user interface on the first electronic device, wherein the first user interface includes a first set of user interface elements overlaid on the stream rendered on the first electronic device, wherein the first set of user interface elements enables the instructor to control the second electronic device;
generate one or more commands based on reception of one or more inputs from the instructor via the one or more user interface elements of the first set of user interface elements; and
control the second electronic device for execution of the one or more commands, wherein the control involves at least one of managing one or more functionalities of the second electronic device, overlaying one or more instruction elements on the feed, or overlaying a reaction of the instructor on the feed, wherein the one or more instruction elements direct the executor to perform one or more actions in the real-world location.
